(19) United States
(12) Patent Application Publication
(10) Pub. No.: US 2013/0312603 A1
(43) Pub. Date: Nov. 28, 2013

(54) PROCESSES AND SORBENTS FOR SEPARATION OF GASES BY CYCLIC ADSORPTION

(71) Applicant: TICONA LLC, Florence, KY (US)

(72) Inventors: Suresh SUBRAMONIAN, Cary, NC (US); Julia HUFEN, Rheinberg (DE); Kerstin LUEDTKE, Markkleeberg (DE); Jason SMITH, Cincinnati, OH (US); Dian CHEN, Union, KY (US)

(73) Assignee: TICONA LLC, Florence, KY (US)

(21) Appl. No.: 13/887,853

(22) Filed: May 6, 2013

Related U.S. Application Data
(60) Provisional application No. 61/642,900, filed on May 4, 2012.
(60) Provisional application No. 61/791,277, filed on Mar. 15, 2013.

(51) Int. Cl. B01J 20/26; B01D 53/04

(52) U.S. Cl. CPC B01J 20/261; B01D 53/0454
USPC 95/26; 502/402

(57) ABSTRACT

A sorbent medium for a cyclic adsorption process comprises at least one self-supporting porous body produced by sintering a mixture of a powdered adsorbent and polyethylene particles having a molecular weight of at least 4×10⁵ g/mol as determined by ASTM-D 4020.

### FIELD

The present invention relates to processes and sorbents for separation of gases by cyclic adsorption processes, especially pressure swing adsorption.

### BACKGROUND

Pressure swing adsorption (PSA) is used extensively in the separation of individual components from gaseous mixtures, such as in the recovery of nitrogen from air, the purification of hydrogen from synthesis gas, methane upgrading from biogas (e.g. landfill gas), ethane separation from methane (shale gas), and carbon dioxide removal from flue gas. In the PSA process, a multi-component gas is passed to at least one of a plurality of adsorption media at an elevated pressure to adsorb at least one strongly adsorbed component while at least one relatively weakly adsorbed component passes through. At a defined time, the feed step is discontinued and the adsorption phase stops and a regeneration phase starts. The bed is depressurized in one or more steps, followed by countercurrent purge and repressurization. In the case of hydrogen production via pressure swing adsorption, the separation occurs from a mixture of gases in a multi-bed system to yield hydrogen gas at high recovery and purity. See, e.g., U.S. Pat. No. 3,430,418 to Wagner, U.S. Pat. No. 3,564,816 to Batta and U.S. Pat. No. 3,986,849 to Fuderer et al.

In conventional PSA processes, the adsorption media are generally granules or beads loaded into packed beds. However, mass transfer and pressure drop problems associated with conventional packed beds impose limitations in operating the process at optimum conditions in terms of energy consumption and overall system efficiency. This is particularly pronounced as the cycle time between the adsorption and desorption steps is decreased. Reducing particle size is the simplest way to decrease mass transfer resistance (which varies as the square of particle size) and trends over the last few decades have seen particle sizes reducing from 2 to 3 mm down to less than 0.7 mm. Combating the accompanying increase in pressure drop with reduction in particle size has led to bed geometries of a “pancake” nature, i.e. L/D ratios considerably less than one. However, considerable gas maldistribution and channeling not to mention potential fluidization of packed beds are issues which emerge when shallow, large diameter packed beds are used.

To obviate the problems associated with packed beds, it has more recently proposed to use self-supporting or structured sorbents such as honeycombs made from or coated with an adsorbent material, such as activated carbon. However, where the adsorbent is deposited (wash coated) in the channels of an inert monolithic support, a honeycomb structure allows lower loading of active sites compared to adsorbent materials in the form of beads or pellets. Also, in the absence of good edge sealing, the possibility exists for fluid leakage at the interface between the monolith and the surrounding support. To date, therefore, there is only limited operational experience with honeycombs in large scale adsorption processes.

There is a continuing need to develop improved adsorbents for PSA systems that will increase the availability and accessibility of active sites resulting in fast mass transfer kinetics and high working capacity and decrease the pressure drop to enable higher throughput without fluidization. According to the invention, it has now been found that a composite block or sheet produced by sintering a mixture of a powdered adsorbent and a high and/or ultra high and/or very high molecular weight polyethylene powder exhibits improved properties as a structured adsorbent for cyclic adsorption processes.

### SUMMARY

In one aspect, the invention resides in a sorbent medium for a cyclic adsorption process, the sorbent medium comprising at least one self-supporting porous body produced by sintering a mixture of a powdered adsorbent and polyethylene particles having a molecular weight of at least 4×10⁵ g/mol as determined by ASTM-D 4020.

Conveniently, the mixture of powdered adsorbent and polyethylene particles is preformed into a required shape and the preformed mixture is sintered to produce each body.

In a further aspect, the invention resides in a cyclic adsorption process for separating a first gas component from a feed gas mixture comprising at least the first gas component and a second gas component, said process comprising: providing a sorbent medium comprising at least one self-supporting porous body produced by sintering a particulate mixture of an adsorbent and a polyethylene binder having a molecular weight of at least 4×10⁵ g/mol; supplying said feed gas mixture to an adsorption zone containing said sorbent medium such that said second gas component is preferentially adsorbed by the sorbent medium; and recovering the first gas component from said adsorption zone.

Conveniently, the polyethylene particles have a molecular weight up to 10×10⁶ g/mol, for example from 4×10⁵ g/mol to 8×10⁶ g/mol, as determined by ASTM-D 4020.

Generally, the polyethylene particles have an average particle size, d₅₀, from 5 to 500 μm, such as from 30 to 350 μm. Conveniently, the particles have a monomodal molecular weight distribution or may have a multimodal molecular weight distribution.

Generally, the polyethylene particles have a bulk density from 0.1 to 0.5 g/ml, such as from 0.2 to 0.45 g/ml.

Preferably, the adsorbent comprises at least one of activated carbon, carbon molecular sieve, diatomaceous earth, silica, zeolite, alumina, an ion exchange resin, titanium silicates, titanium oxides, and metal oxides and hydroxides.

Generally, the weight ratio of powdered adsorbent to polyethylene binder in the sintered mixture is in the range from 90:10 to 50:50, such as from 80:20 to 60:40.

In one embodiment, the adsorbent comprises activated carbon having a bulk density of from 0.3 to 0.8 g/ml and a BET surface area from about 500 to about 2000 m²/g.

### BRIEF DESCRIPTION OF THE DRAWINGS

FIG. 1 shows the nitrogen and oxygen isotherms at 25° C. normalized by carbon weight for the sintered sorbents of Examples 12 and 13 and the as-supplied (Comparative Example 1) and manually ground (Comparative Example 2) CMS260 activated carbon pellets.

FIG. 2 plots the nitrogen and oxygen sorption rate constants for the sintered sorbents of Examples 12 and 13 and the as-supplied (Comparative Example 1) and manually ground (Comparative Example 2) CMS260 activated carbon pellets.

FIG. 3 shows the nitrogen and oxygen isotherms at 25° C. normalized by carbon weight for the sintered sorbent of Example 14 and the as-supplied (Comparative Example 3) and manually ground (Comparative Example 4) CMS240 activated carbon pellets.

FIG. 4 plots the nitrogen and oxygen sorption rate constants for the sintered sorbents of Example 14 and the as-supplied (Comparative Example 3) and manually ground (Comparative Example 4) CMS240 activated carbon pellets.

### DETAILED DESCRIPTION

Described herein are a sorbent medium and its use in a process for the separation of gases by cyclic adsorption. In this respect, cyclic adsorption is used herein to mean a process, such as pressure swing adsorption (PSA) or vacuum swing adsorption (VSA), for separating a first gas component from a feed gas mixture comprising at least a first gas component and a second gas component. The process employs a sorbent medium which preferentially adsorbs the second gas component but not the first gas component. The process cycles between at least two steps. In a first step, the feed gas mixture is supplied to an adsorption zone containing the sorbent medium such that the second gas component is preferentially adsorbed by the sorbent medium and a purified first gas component, the product gas, can be recovered from adsorption zone. When the sorption capacity of the sorbent medium has decreased by a predetermined amount, the supply of feed gas mixture is terminated and the second gas component is desorbed from the sorbent medium during a second step. Normally after a purge step to regenerate the adsorbent, the adsorption and desorption cycles can then be repeated. In the case of rapid cycle pressure swing adsorption (RCPSA), cycling between the adsorption and desorption steps can occur up to 50 times/minute or more.

In the present process, the sorbent medium comprises at least one self-supporting porous body produced by sintering a mixture of a powdered adsorbent and polyethylene particles having a molecular weight of at least 4×10⁵ g/mol and generally up to 10×10⁶ g/mol, for example from 4×10⁵ g/mol to 8×10⁶ g/mol, as determined by ASTM-D 4020. The polyethylene powder may have a monomodal molecular weight distribution or may have a multimodal, generally bimodal, molecular weight distribution. The particle size of the polyethylene powder used to produce the filters can vary significantly but in general the powder has an average particle size, d₅₀, from 5 to 500 μm, such as from 30 to 350 μm, for example from 30 to 200 μm. Where the as-synthesized powder has a particle size in excess of the desired value, the particles can be ground to the desired particle size. The bulk density of the polyethylene powder is typically from 0.1 to 0.5 g/ml, such as from 0.2 to 0.45 g/ml.

The high molecular weight polyethylene powder used to produce the sorbent medium is typically produced by the catalytic polymerization of ethylene monomer or optionally with one or more other 1-olefin co-monomers, the 1-olefin content in the final polymer being less or equal to 10% of the ethylene content, with a heterogeneous catalyst and an organo aluminum- or magnesium compound as cocatalyst. The ethylene is usually polymerized in gaseous phase or slurry phase at relatively low temperatures and pressures. The polymerization reaction may be carried out at a temperature from 50° C. to 100° C. and pressures in the range from 0.02 to 2 MPa.

The molecular weight of the polyethylene can be adjusted by adding hydrogen. Altering the temperature and/or the type and concentration of the cocatalyst may also be used to fine tune the molecular weight. Additionally, the reaction may occur in the presence of antistatic agents to avoid wall fouling and product contamination.

Suitable catalyst systems include but are not limited to Ziegler-Natta type catalysts. Typically Ziegler-Natta type catalysts are derived from a combination of transition metal compounds of Groups 4 to 8 of the Periodic Table and alkyl- or hydrid derivatives of metals from Groups 1 to 3 of the Periodic Table. Transition metal derivatives used usually comprise the metal halides or esters or combinations thereof. Exemplary Ziegler-Natta catalysts include those based on the reaction products of organo aluminum- or magnesium compounds, for example, but not limited to, aluminum- or magnesium alkyls and titanium-, vanadium- or chromium halides or esters. The heterogeneous catalyst may be either unsupported or supported on a porous fine grained support, such as silica or magnesium chloride. Such support can be added during synthesis of the catalyst or may be obtained as a chemical reaction product of the catalyst synthesis itself.

In one embodiment, a suitable catalyst system could be obtained by the reaction of a titanium(IV) compound with a trialkyl aluminum compound in an inert organic solvent at temperatures in the range of −40° C. to 100° C., preferably −20° C. to 50° C. The concentrations of the starting materials are in the range of 0.1 to 9 mol/L, preferably 0.2 to 5 mol/L, for the titanium(IV) compound and in the range from 0.01 to 1 mol/L, preferably 0.02 to 0.2 mol/L for the trialkyl aluminum compound. The titanium component is added to the aluminum component over a period of 0.1 min to 60 min, preferably 1 min to 30 min, the molar ratio of titanium and aluminum in the final mixture being in the range of 1:0.01 to 1:4.

In another embodiment, a suitable catalyst system is obtained by a one or two-step reaction of a titanium(IV) compound with a trialkyl aluminum compound in an inert organic solvent at temperatures in the range of −40° C. to 200° C., preferably −20° C. to 150° C. In the first step the titanium(IV) compound is reacted with the trialkyl aluminum compound at temperatures in the range of −40° C. to 100° C., preferably −20° C. to 50° C. using a molar ratio of titanium to aluminum in the range of 1:0.1 to 1:0.8. The concentrations of the starting materials are in the range of 0.1 to 9.1 mol/L, preferably 5 to 9.1 mol/L, for the titanium(IV) compound and in the range of 0.05 and 1 mol/L, preferably 0.1 to 0.9 mol/L for the trialkyl aluminum compound. The titanium component is added to the aluminum compound over a period of 0.1 min to 800 min, preferably 30 min to 600 min. In a second step, if applied, the reaction product obtained in the first step is treated with a trialkyl aluminum compound at temperatures in the range of −10° C. to 150° C., preferably 10° C. to 130° C. using a molar ratio of titanium to aluminum in the range of 1:0.01 to 1:5.

In yet another embodiment, a suitable catalyst system is obtained by a procedure wherein, in a first reaction stage, a magnesium alcoholate is been reacted with a titanium chloride in an inert hydrocarbon at a temperature of 50° to 100° C. In a second reaction stage the reaction mixture formed is subjected to a heat treatment for a period of about 10 to 100 hours at a temperature of 110° to 200° C. accompanied by an evolution of alkyl chloride until no further alkyl chloride is split off, and the solid is then freed from soluble reaction products by washing several times with a hydrocarbon.

In a further embodiment, catalysts supported on silica, like for example the commercially available catalyst system Sylopol 5917 can also be used.

Using such catalyst systems, the polymerization is normally carried out in suspension at low pressure and temperature in one or multiple steps, continuous or batch. The polymerization temperature is typically in the range of 30° C. to 130° C., preferably is the range of 50° C. and 90° C. and the ethylene partial pressure is typically less than 10 MPa, preferably 0.05 and 5 MPa. Trialkyl aluminums, like for example but not limited to isoprenyl aluminum and triisobutyl aluminum, are used as co-catalyst such that the ratio of Al:Ti (co-catalyst versus catalyst) is in the range of 0.01 to 100:1, more preferably is the range of 0.03 to 50:1. The solvent is an inert organic solvent as typically used for Ziegler type polymerizations. Examples are butane, pentane, hexane, cyclohexene, octane, nonane, decane, their isomers and mixtures thereof. The polymer molecular mass is controlled through feeding hydrogen. The ratio of hydrogen partial pressure to ethylene partial pressure is in the range of 0 to 50, preferably the range of 0 to 10. The polymer is isolated and dried in a fluidized bed drier under nitrogen. The solvent may be removed through steam distillation in case of using high boiling solvents. Salts of long chain fatty acids may be added as a stabilizer. Typical examples are calcium-, magnesium- and zinc stearate.

Optionally, other catalysts such as Phillips catalysts, metallocenes and post metallocenes may be employed. metallocene and postmetallocene catalysts are also well known. Generally a cocatalyst such as alumoxane or alkyl aluminum or alkyl magnesium compound is also employed. For example, U.S. Patent Application Publication No. 2002/0040113 to Fritzsche et al., the entire contents of which are incorporated herein by reference, discusses several catalyst systems for producing ultra-high molecular weight polyethylene. Other suitable catalyst systems include Group 4 metal complexes of phenolate ether ligands such as are described in International Patent Publication No. WO2012/004675, the entire contents of which are incorporated herein by reference.

The powdered adsorbent employed in the sorbent medium will depend on the nature of the feed gas mixtures to be separated in the present process but generally will be selected from activated carbon, carbon molecular sieve, diatomaceous earth, silica, zeolite, alumina, ion exchange resins, titanium silicates, titanium oxides, and metal oxides and hydroxides. Generally, the weight ratio of powdered adsorbent to polyethylene binder in the sintered mixture varies from 90:10 to 50:50, such as from 80:20 to 60:40, and typically is about 75:25.

In one embodiment, the powdered adsorbent comprises carbon molecular sieve having a bulk density of from 0.3 to 0.8 g/ml, a particle size from about 1 to about 2000 μm and a BET surface area of about 500 to about 2000 m²/g, such as about 800 to about 1500 m²/g. In some cases, it may be desirable to employ as the adsorbent carbon molecular sieve having two or more particle sizes, for example a first carbon molecular sieve having a particle size from about 1 to about 2000 μm and a second carbon molecular sieve having a different particle size from about 1 to about 2000 μm.

Generally, the sorbent medium should have a high porosity, such as at least 35% and preferably at least 40%, and a low pressure drop, such as less than 48 inches of water/ft of bed (3.9 mbar/cm) at a superficial linear air velocity of 47 ft/min (0.24 m/sec), preferably less than 24 inches of water/ft of bed (2 mbar/cm) at a superficial linear air velocity of 47 ft/min (0.24 m/sec). Typically, the sorbent medium has an average pore size from 1 μm to 500 μm, such as from 10 μm to 400 μm.

In one embodiment, the sorbent medium may be formed by a free sintering process which involves introducing the mixture comprising the polyethylene polymer and the powdered adsorbent into either a partially or totally confined space, e.g., a mold, and subjecting the molding powder to heat sufficient to cause the polyethylene particles to soften, expand and contact one another. The mold can be made of steel, aluminum or other metals.

Sintering processes are well-known in the art. The mold is heated to the sintering temperature, which is normally in the range of about 100° C. to 300° C., such as 140° C. to 300° C., for example 140° C. to 240° C. The mold is typically heated in a convection oven, hydraulic press or by infrared heaters. The heating time will vary and depend upon the mass of the mold and the geometry of the molded article. Typical heating time will lie within the range of about 5 to about 300 minutes, more typically in the range of about 15 minutes to about 100 minutes. The mold may also be vibrated to ensure uniform distribution of the powder.

During sintering, the surface of individual polymer particles fuse at their contact points forming a porous structure. The polymer particles coalesce together at the contact points due to the diffusion of polymer chains across the interface of the particles. The interface eventually disappears and mechanical strength at the interface develops. Subsequently, the mold is cooled and the porous article removed. The cooling step may be accomplished by conventional means, for example it may be performed by blowing air past the article or the mold, or contacting the mold with a cold fluid. Upon cooling, the polyethylene typically undergoes a reduction in bulk volume. This is commonly referred to as “shrinkage.” A high degree of shrinkage is generally not desirable as it can cause shape distortion in the final product.

Pressure may be applied during the sintering process, if desired. However, subjecting the particles to pressure causes them to rearrange and deform at their contact points until the material is compressed and the porosity is reduced. In general, therefore, the sintering process employed herein is conducted in the absence of applied pressure.

In one embodiment, the molded sintered body is in the form of a cylindrical block which, in use in the adsorption zone of a cyclic adsorption process, is arranged such that the feed gas mixture flows in an axial direction through the tortuous flow channels of the porous block where it contacts the adsorbent contained within the block. In some embodiments, the sintered block may be provided with a plurality of continuous or non-continuous channels in the axial direction and the feed gas mixture flows in the axial direction through the flow channels. Extensive and continual mixing along the flow path enables transport of the gas mixture through the tortuous channels of the porous block where it contacts the adsorbent contained within the block. The above referenced embodiment with flow channels is anticipated to exhibit lower pressure drop compared to an embodiment with no flow channels.

In another embodiment, the molded sintered body is in the form of a cylindrical block with open core. In use, the feed gas mixture enters the inner annular zone and flows radially outward through the sintered body to the outer annular zone where the product gas is collected. Alternatively, the feed gas mixture can enter the outer annular zone and flow radially inward through the sintered body to the inner annular zone where the product gas is collected.

In yet another embodiment, the mixture of adsorbent powder and polyethylene binder is formed and sintered into uniquely shaped blocks that can be patterned and assembled into a cylindrical shape. For example, blocks may themselves be cylindrical and be stacked in layers to define the desired cylindrical body. Alternatively, each block may define a segment of a cylinder such that a plurality of blocks define each layer, conveniently with the sub-units in adjacent layers being offset to minimize gas channeling effects.

In another embodiment, the mixture of adsorbent powder and polyethylene binder is formed into a sheet by a batch sintering process as described above. The sheet is then stamped or die cut to the desired cylindrical shape and stacked in layers to the desired thickness. The sheet stack can be externally supported to form a self-standing assembly. Alternatively, the mixture of adsorbent powder and polyethylene binder is formed into a sheet by a continuous sintering process in which, for example, the mixture is loaded into a hopper and fed from the hopper at a desired rate to a moving conveyor belt. The mixture is then transported by the conveyor belt between two sets of heated rolls with a preset gap (based on sheet thickness) that heat the resin to the softening temperature and cause point bonding of the adsorbent powder to form a continuous sheet. The rolls apply low to moderate pressure, preferably zero to low, pressure during consolidating process and, after passage between the rolls, the sintered sheet is cooled and then passed to a product recovery section. In the product recovery section, the sintered sheet is either wound on a roller or slit into slabs to be stamped or die cut to the desired circular or cylindrical shape.

Where the mixture of adsorbent powder and polyethylene binder is sintered into a continuous sheet, the sintered sheet may be wound around a mandrel into a spiral form optionally with spacers being used to maintain a substantially constant spacing between adjacent loops of the sheet. Alternatively, the continuous sheet can be slit into a plurality of generally rectangular tiles which are stacked on edge with spacers between the tiles and reinforced internally or externally to produce a self-supporting assembly having parallel channels defined between the adjacent tiles. The feed gas mixture flows axially through the channels and contacts the adsorbent during its passage through the channels. It is important to ensure the spacers provide uniform spacing between adjacent tiles to prevent channeling and other flow maldistribution effects.

Irrespective of its configuration, the high molecular weight polyethylene-bound sorbent medium described herein is useful in a large variety of gaseous separations, including the recovery of nitrogen from air, the purification of hydrogen from synthesis gas, methane upgrading from biogas (e.g. landfill gas), ethane separation from methane (shale gas), and carbon dioxide removal from flue gas. The present sorbent medium can also be employed in RCPSA applications.

The invention will now be more particularly described with reference to the following non-limiting Examples.

In the Examples, and the remainder of the specification, the following tests are used to measure the various parameters cited herein.

Particle size measurements cited herein are average particle size values and are obtained by a laser diffraction method according to ISO 13320.

Polyethylene powder bulk density measurements are obtained according to DIN 53466.

Activated carbon bulk density measurements are obtained according to ASTM D2854.

Polyethylene molecular weight molecular weight measurements are determined by ASTM-D 4020.

BET surface area measurements are obtained according to DIN 66131.

### Examples 1 to 8

A series of commercial HMW, VHMW and UHMW PE resins having the properties listed in Table 1 are used to fabricate sintered sorbents.

TABLE 1

| Example | Bulk density, g/cc | d50, μm | MW × 10⁶ g/mol |
|---|---|---|---|
| 1 | 0.23 | 35 | 4 |
| 2 | 0.23 | 120 | 4 |
| 3 | 0.23 | 200 | 4 |
| 4 | 0.45 | 120 | 5 |
| 5 | 0.45 | 60 | 7.3 |
| 6 | 0.45 | 120 | 7.3 |
| 7 | 0.45 | 110 | 0.8 |
| 8 | 0.23 | 120 | 0.47 |

### Examples 9 to 11

Blends of 25 wt % of the resin used in Example 2 with 75 wt % of three activated carbon samples having different BET surface areas were sintered into blocks and the pressure drop and BET surface area values of the sintered products were determined. The results are listed in Table 2 and show that the reduction in BET surface area of the sintered block as compared with the activated carbon starting material is proportional to resin binder level. Also, the pressure drop through the bed decreases as the carbon particle size increases.

TABLE 2

| | Carbon | Resin/ | ΔP, | Resin/ | BET |
|---|---|---|---|---|---|
| Exam- | type, BET | carbon | mbar/ | carbon | reduc- |
| ple | area (m²/g) | blend | cm sheet | BET (m²/g) | tion |
| 2 | | 100/0 | 16 | | |
| 9 | fine C, 773 | 25/75 | 40 | 580 | 25% |
| 10 | medium C, 1077 | 25/75 | 16 | 800 | 26% |
| 11 | coarse C, 904 | 25/75 | 14 | 670 | 26% |

### Examples 12 to 13

Sintered sorbents were produced from blends of the PE resins described in Table 3 and varying amounts of carbon molecular seive supplied by Hengye USA as CMS 260, after the as-supplied 1.2 mm diameter by 3-5 mm length carbon pellets (Comparative Example 1) had been manually ground to a powder with a 40×70 mesh size (Comparative Example 2).

TABLE 3

| | | Resin/carbon | | PE Bulk | |
|---|---|---|---|---|---|
| | | blend by | PE Mol. | Density | |
| Example | Resin # | weight | Wt. | (g/mL) | PE d₅₀ μm |
| 12 | Ex. 2 | 35/65 | 4 × 10⁶ | 0.23 | 120 |
| 13 | Ex. 8 | 25/75 | 4.7 × 10⁵ | 0.23 | 120 |

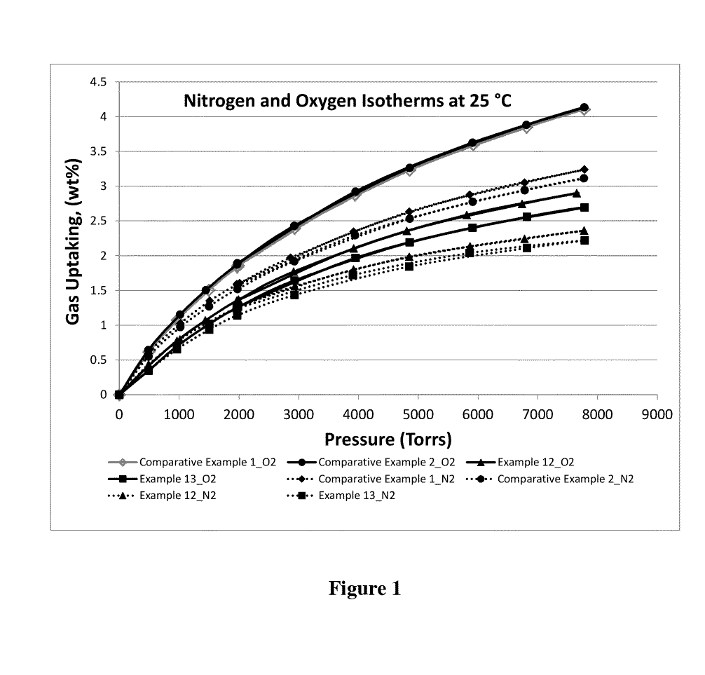

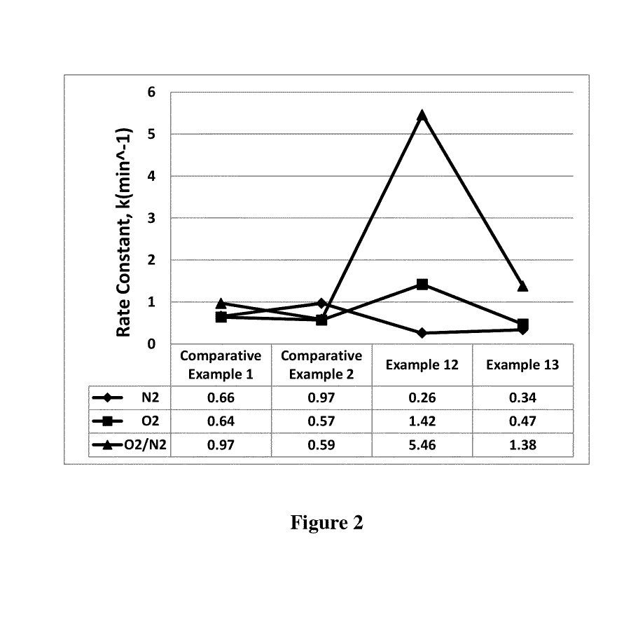

The resultant sintered sorbents were then tested at 25° C. using a gravimetric analyzer to obtain the O₂ and N₂ adsorption isotherm curves and the adsorption rate constants were determined. The results are shown in FIGS. 1 and 2, which also provide equivalent sorption data for the activated carbon alone, both as-supplied (Comparative Example 1) and after manual grinding (Comparative Example 2).

### Example 14

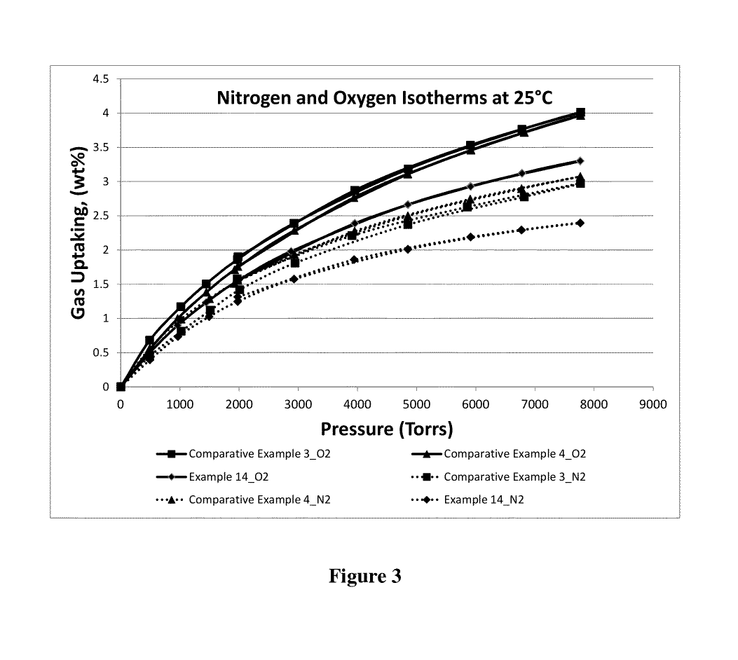

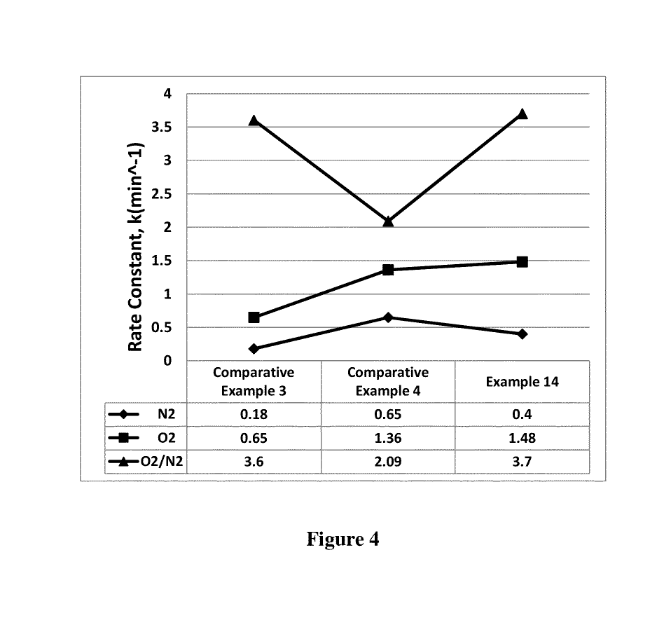

The sintered sorbent and tests of Example 13 were repeated but using carbon molecular sieve supplied by Weihai Huatai Molecular Sieve Co., Ltd as CMS 240, after the as-supplied 1.2 mm diameter by 3-5 mm length carbon pellets (Comparative Example 3) had been machine ground to a powder with a 40×70 mesh size (Comparative Example 4). The results for Example 14 are shown in FIGS. 3 and 4, which also provide equivalent sorption data for the carbon molecular sieve alone, both as-supplied (Comparative Example 3) and after manual grinding (Comparative Example 4).

1. A sorbent medium for a cyclic adsorption process, the sorbent medium comprising at least one self-supporting porous body produced by sintering a mixture of a powdered adsorbent and polyethylene particles having a molecular weight of at least 4×10⁵ g/mol as determined by ASTM-D 4020.

2. The sorbent medium of claim 1, wherein the polyethylene particles have a molecular weight from 4×10⁵ g/mol to 8×10⁶ g/mol as determined by ASTM-D 4020.

3. The sorbent medium of claim 1, wherein the polyethylene particles have an average particle size, d₅₀, from 5 to 500 μm.

4. The sorbent medium of claim 3, wherein the polyethylene particles have an average particle size, d₅₀, from 30 to 350 μm.

5. The sorbent medium of claim 1, wherein the polyethylene particles have a bulk density between 0.1 and 0.5 g/ml.

6. The sorbent medium of claim 1, wherein the weight ratio of powdered adsorbent to polyethylene binder in the sintered mixture is in the range from 90:10 to 50:50.

7. The sorbent medium of claim 6, wherein the weight ratio of powdered adsorbent to polyethylene binder in the sintered mixture is in the range from 80:20 to 60:40.

8. The sorbent medium of claim 1, wherein the powdered adsorbent comprises at least one of activated carbon, carbon molecular sieve, diatomaceous earth, silica, zeolite, alumina, an ion exchange resin, titanium silicates, titanium oxides, and metal oxides and hydroxides.

9. The sorbent medium of claim 1, wherein the powdered adsorbent comprises carbon molecular sieve having a bulk density of from 0.3 to 0.8 g/ml.

10. The sorbent medium of claim 1, wherein the powdered adsorbent comprises carbon molecular sieve having a BET surface area from 500 to 2000 m²/g.

11. The sorbent medium of claim 1, wherein the powdered adsorbent comprises a first carbon molecular sieve having a particle size from about 1 to about 2000 μm and a second carbon molecular sieve having a particle size from about 1 to about 2000 μm.

12. A cyclic adsorption process for separating a first gas component from a feed gas mixture comprising at least a first gas component and a second gas component, said process comprising:
providing a sorbent medium comprising at least one self-supporting porous body produced by sintering a particulate mixture of a powdered adsorbent and a polyethylene binder having a molecular weight of at least 4×10⁵ g/mol;
supplying said feed gas mixture to an adsorption zone containing said sorbent medium such that said second gas component is preferentially adsorbed by the sorbent medium; and
recovering the first gas component from said adsorption zone.

13. The process of claim 12, wherein the polyethylene particles have a molecular weight from 4×10⁵ g/mol to 8×10⁶ g/mol as determined by ASTM-D 4020.

14. The process of claim 12, wherein the polyethylene particles have an average particle size, d₅₀, from 5 to 500 μm.

15. The process of claim 14, wherein the polyethylene particles have an average particle size, d₅₀, from 30 to 350 μm.

16. The process of any one of claim 12, wherein the polyethylene particles have a bulk density between 0.1 and 0.5 g/ml.

17. The process of claim 12, wherein the weight ratio of powdered adsorbent to polyethylene binder in the sintered mixture is in the range from 90:10 to 50:50.

18. The process of claim 17, wherein the weight ratio of powdered adsorbent to polyethylene binder in the sintered mixture is in the range from 80:20 to 60:40.

19. The process of claim 12, wherein the powdered adsorbent comprises at least one of activated carbon, carbon molecular sieve, diatomaceous earth, silica, zeolite, alumina, an ion exchange resin, titanium silicates, titanium oxides, and metal oxides and hydroxides.

20. The process of claim 12, wherein the powdered adsorbent comprises carbon molecular sieve having a bulk density of from 0.3 to 0.8 g/ml.

21. The process of claim 12, wherein the powdered adsorbent comprises carbon molecular sieve having a BET surface area from 500 to 2000 m²/g.

22. The process of claim 12, wherein the powdered adsorbent comprises a first carbon molecular sieve having a particle size from about 1 to about 2000 μm and a second carbon molecular sieve having a particle size from about 1 to about 2000 μm.
